(19) United States
(12) Patent Application Publication
(10) Pub. No.: US 2025/0364622 A1
(43) Pub. Date: Nov. 27, 2025

(54) STORAGE BATTERY SYSTEM AND METHOD FOR CONTROLLING STORAGE BATTERY SYSTEM

(71) Applicant: Mitsubishi Electric Corporation, Tokyo (JP)

(72) Inventor: Satoshi HARA, Tokyo (JP)

(73) Assignee: Mitsubishi Electric Corporation, Tokyo (JP)

(21) Appl. No.: 18/872,287

(22) PCT Filed: Jul. 13, 2022
(86) PCT No.: PCT/JP2022/027511

§ 371 Date: Dec. 6, 2024

(51) Int. Cl. H01M 10/633; H01M 10/42; H01M 10/48; H01M 10/613; H01M 10/627; H01M 10/6569

(52) U.S. Cl. CPC H01M 10/633; H01M 10/425; H01M 10/482; H01M 10/486; H01M 10/613; H01M 10/627; H01M 10/6569; H01M 2010/4271; H01M 2220/10

(57) ABSTRACT

A storage battery system of the present disclosure includes: a plurality of storage battery modules each including a BMU and at least one temperature sensor; a control device which controls the plurality of storage battery modules via the BMUs; and an air conditioner of which at least an air volume is controlled for each storage battery module on the basis of a target temperature set for each storage battery module. The control device includes a life prediction unit which predicts a life using a capacity and a measured temperature for each storage battery module, and a temperature control unit which calculates the target temperature for each storage battery module so that the life of each storage battery module predicted at a control start point becomes an averaged life after the control start point, and transmits the target temperature to the air conditioner.

### TECHNICAL FIELD

The present disclosure relates to a storage battery system and a method for controlling a storage battery system.

### BACKGROUND ART

With increase in demand for renewable energy, it is expected that photovoltaic generation, wind power generation, and the like will spread. Since generated power from renewable energy varies by the weather or the like, such power generation is often implemented with a large-sized storage battery system provided together for the purposed of stabilizing a power grid. In addition, with size increase in renewable energy facilities in recent years, a storage battery system having a large size and a large capacity is needed and storage battery systems directed to long-term operation are spreading. The operation period of such a storage battery system having a large capacity and a large size is assumed to be 10 to 20 years, and therefore technology for performing high-efficiency operation stable over a long period is needed.

However, in such a large-sized storage battery system, temperatures might vary among the positions of storage battery modules composing the storage battery system, leading to variations in the lives of the storage battery modules. Regarding a storage battery module whose life has ended in a usage period, it is necessary to replace the storage battery module or perform replacement in the entire storage battery system under the determination that the life of the entire storage battery system has ended even though there are sound storage battery modules. Therefore, it is important to realize such technology that temperatures in the storage battery system are controlled so that the lives of storage battery modules in the storage battery system coincide with each other, thus prolonging the life of the entire storage battery system.

As technology for prolonging the life of a storage battery system, for example, a power storage system and a power storage system temperature control method described in Patent Document 1 are configured such that the inside of the power storage system is divided into areas and start and stop of fans are determined for each area on the basis of difference among average temperatures in the respective areas, so as to keep the temperatures in the power storage system uniform.

### CITATION LIST

### Patent Document

Patent Document 1: Japanese Laid-Open Patent Publication No. 2014-203536

### SUMMARY OF THE INVENTION

### Problem to be Solved by the Invention

In the large-capacity power storage system temperature control method disclosed in Patent Document 1, fan control is performed on the basis of difference among average temperatures in the respective areas. Therefore, depending on a threshold for the temperature difference, a temperature distribution occurs, and due to the temperature distribution that has occurred, difference arises among the deterioration degrees of the storage battery modules, so that it is difficult to equalize the lives of the storage battery modules placed in the respective areas.

In addition, in a case where the average temperature in an area is low (e.g., about 15° C.), an air conditioner in the storage battery system cools a storage battery module in an area where operation is being performed at a normal temperature (e.g., 25° C.) at which deterioration is small, thus promoting deterioration and decreasing the life. Further, since a storage battery has a characteristic that deterioration in operation at the normal temperature is small, cooling a storage battery module in an area where cooling is not needed, such as a normal temperature area, leads to reduction in efficiency of the air conditioner.

The present disclosure has been made to solve the above problem, and an object of the present disclosure is to provide a storage battery system and a method for controlling a storage battery system that enable high-efficiency operation stable over a long period in a case where the storage battery system has a large capacity.

### Means to Solve the Problem

A storage battery system according to the present disclosure includes: a plurality of storage battery modules each including a plurality of storage battery cells, a battery management unit which controls the plurality of storage battery cells, and at least one temperature sensor; a control device which controls the plurality of storage battery modules via the battery management units; and an air conditioner of which at least one of an air volume, a wind direction, and a wind-blow temperature of blown wind is controlled for each of the plurality of storage battery modules on the basis of a target temperature set for each storage battery module. The control device includes a life prediction unit which predicts a life of each of the plurality of storage battery modules, using a capacity of each of the plurality of storage battery modules and a temperature measured by the temperature sensor for each of the plurality of storage battery modules, and a temperature control unit which calculates the target temperature for each of the plurality of storage battery modules so that the life of each of the plurality of storage battery modules predicted by the life prediction unit at a control start point becomes an averaged life after the control start point, and transmits the target temperature to the air conditioner.

A method for controlling a storage battery system according to the present disclosure is a method for controlling a storage battery system including a plurality of storage battery modules each including a plurality of storage battery cells, a battery management unit which controls the plurality of storage battery cells, and at least one temperature sensor, the method including the steps of: acquiring a capacity of each of the plurality of storage battery modules via the battery management units; measuring a temperature of the storage battery module by at least one temperature sensor provided in each of the plurality of storage battery modules; predicting a life of each storage battery module, using the capacity and the temperature of each of the plurality of storage battery modules; calculating a target temperature for each of the plurality of storage battery modules so that the life predicted for each of the plurality of storage battery modules becomes an averaged life; and controlling at least one of an air volume, a wind direction, and a wind-blow temperature of wind blown for each of the storage battery modules from an air conditioner, on the basis of the target temperature.

### Effect of the Invention

With the storage battery system and the method for controlling the storage battery system according to the present disclosure, the lives of a plurality of storage battery modules provided in the storage battery system can be made uniform, thus making it possible to use the entire storage battery system until the end of the original target life.

### BRIEF DESCRIPTION OF THE DRAWINGS

FIG. 1 is an overall view showing a storage battery system according to embodiment 1;

FIG. 2 shows the configuration of the storage battery system according to embodiment 1;

FIG. 3 is a block diagram showing the configuration of the storage battery system according to embodiment 1;

FIG. 4 schematically shows deterioration amounts in preservation deterioration and in combination of preservation deterioration and cycle deterioration of a storage battery module in the storage battery system according to embodiment 1;

FIG. 5 shows transition of the capacity of each storage battery module in the storage battery system according to embodiment 1;

FIG. 6 shows correlation data of a deterioration factor and a temperature of a storage battery module in the storage battery system according to embodiment 1;

FIG. 7 shows transition of the capacity of each storage battery module in a case where a temperature distribution has occurred in the storage battery system according to embodiment 1;

FIG. 8 shows the relationship between a temperature distribution and deterioration amounts of storage battery modules from the start of a usage period to a control start point in the storage battery system according to embodiment 1;

FIG. 9 shows the relationship between a temperature distribution and deterioration amounts of storage battery modules between control start points in the storage battery system according to embodiment 1;

FIG. 10 shows the relationship between a temperature distribution and deterioration amounts of storage battery modules between control start points in the storage battery system according to embodiment 1;

FIG. 11 shows the relationship between a temperature distribution and deterioration amounts of storage battery modules between control start points in the storage battery system according to embodiment 1;

FIG. 12 shows an example of a method for controlling the temperatures of storage battery modules using the capacities of the respective storage battery modules at a control start point, in the storage battery system and a storage battery system control method according to embodiment 1;

FIG. 13 shows transition of the capacities of storage battery modules in a storage battery system in a case of applying a storage battery system control method according to a comparative example;

FIG. 14 shows transition of the capacities of the storage battery modules in the storage battery system in the case of applying the storage battery system control method according to the comparative example;

FIG. 15 is a flowchart illustrating the storage battery system control method according to embodiment 1;

FIG. 16 shows control according to a comparative example and temperature transition in a case where the control is applied;

FIG. 17 shows the storage battery system control according to embodiment 1 and capacity transition in a case where the control is applied;

FIG. 18 shows control according to a comparative example and capacity transition in a case where the control is applied;

FIG. 19 shows the storage battery system control according to embodiment 1 and capacity transition in a case where the control is applied;

FIG. 20 shows control according to a comparative example and capacity transition in a case where the control is applied;

FIG. 21 shows the storage battery system control according to embodiment 1 and temperature transition in a case where the control is applied;

FIG. 22 shows transition of power consumption of an air conditioner before and after the storage battery system control method according to embodiment 1 is applied;

FIG. 23 shows a hardware example of the storage battery system according to embodiment 1.

### DESCRIPTION OF EMBODIMENTS

### Embodiment 1

### <Configuration of Storage Battery System According to Embodiment 1>

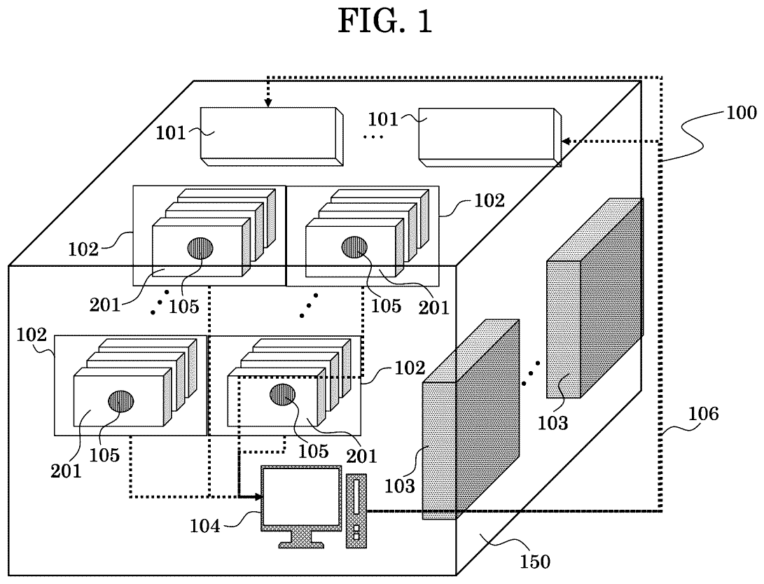

FIG. 1 is an overall view of a storage battery system 100 according to embodiment 1. The storage battery system 100 includes air conditioners 101, storage battery racks 102, converters 103, a control device 104, temperature sensors 105, and signal lines 106. The storage battery system 100 is stored in a housing 150, for example.

The storage battery rack 102 has therein a plurality of storage battery modules 201. A temperature sensor 105 is provided to at least one of the plurality of storage battery modules 201 stored in the storage battery rack 102. The temperature sensors 105 may be provided to all the storage battery modules 201 stored in the storage battery rack 102.

The temperature sensor 105 may be provided for each of a plurality of storage battery cells 203 composing the storage battery module 201. In this case, an average value of the temperatures of the plurality of storage battery cells 203 measured for each storage battery cell 203 may be used as the temperature of the storage battery module 201. One temperature sensor 105 may be provided in the storage battery module 201, and a temperature measured by the one temperature sensor 105 may be used as the temperature of the storage battery module 201.

The air conditioner 101 is an air conditioner of which the wind direction, the air volume, and the wind-blow temperature can be controlled, and is controlled by the control device 104 via the signal line 106. That is, the wind direction, the air volume, the wind-blow temperature, and the like of wind blown from the air conditioner 101 are controlled in accordance with a command from the control device 104.

The converter 103 may be an AC/DC converter which converts DC current to AC current, a DC/DC converter which converts voltage of the storage battery rack to any voltage, or the like.

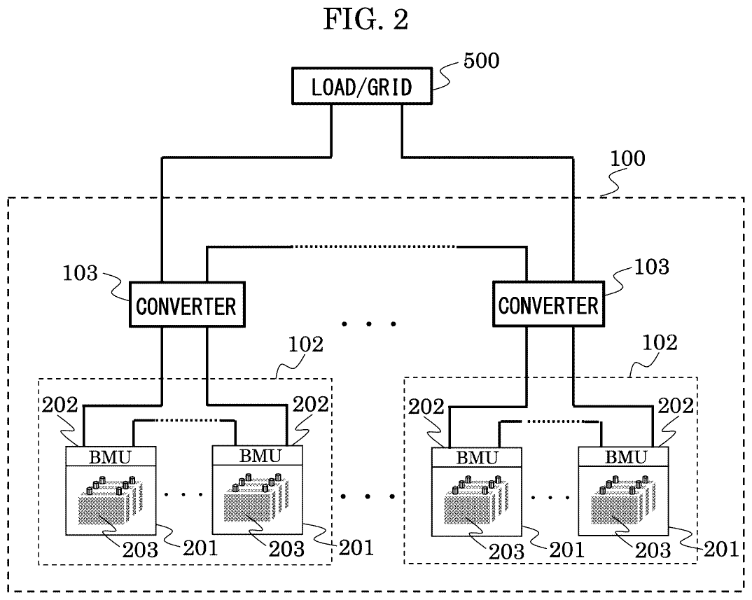

FIG. 2 shows a part of the configuration of the storage battery system 100 according to embodiment 1. In the storage battery rack 102, the plurality of storage battery modules 201 are connected in series and parallel. Each of the plurality of storage battery modules 201 stored in the storage battery rack 102 includes one battery management unit (BM?J) 202 and a plurality of storage battery cells 203 connected in series and parallel.

The storage battery cell 203 in the storage battery module 201 is, for example, a chargeable and dischargeable secondary battery. The storage battery cell 203 is formed of a lithium-ion battery, a nickel-hydrogen battery, a lead storage battery, or the like.

For the purpose of preventing overcharge, overdischarge, overvoltage, overcurrent, temperature abnormality, and the like of the storage battery cell 203, upper and lower limit voltages, maximum charge and discharge currents, a maximum cell temperature, and the like are set for the BMU 202. The BMU 202 has a function of protecting the storage battery cells 203 and a status monitoring function for the storage battery cells 203 and the storage battery module 201, such as voltage measurement, current measurement, and power measurement for the storage battery cells 203, temperature measurement for the storage battery module 201, full-charge management, and remaining capacity management.

The storage battery rack 102 in which the plurality of storage battery modules 201 are provided is connected to the converter 103. Each of the plurality of storage battery racks 102 is connected to a load/grid 500 via the converter 103.

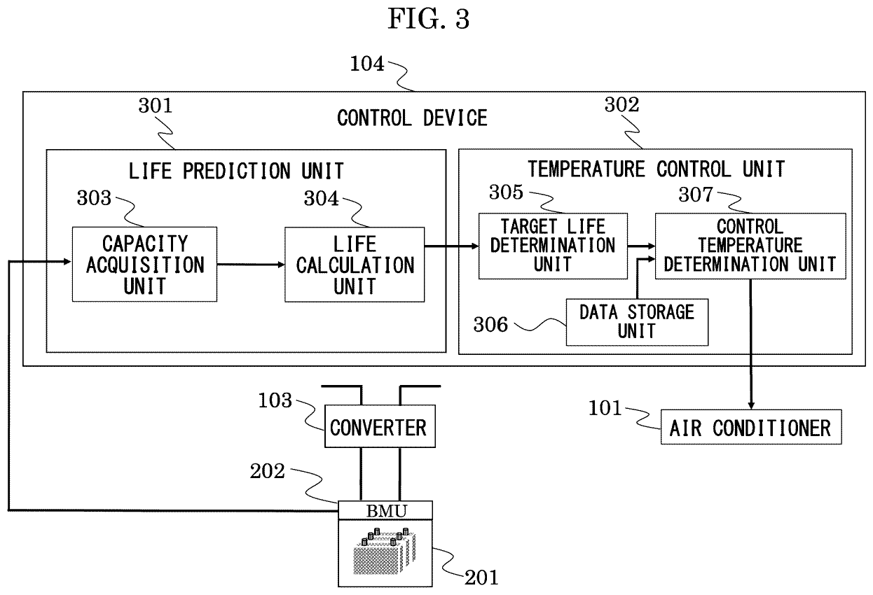

FIG. 3 is a block diagram showing the configuration of the storage battery system 100 according to embodiment 1. The control device 104 includes a life prediction unit 301 and a temperature control unit 302. The life prediction unit 301 includes a capacity acquisition unit 303 which acquires the capacity of the storage battery module 201, and a life calculation unit 304 which estimates the life of the storage battery module 201 on the basis of capacity change over time.

The temperature control unit 302 forming a part of the control device 104 includes a target life determination unit 305 which determines a target life for the storage battery module 201, a data storage unit 306 which stores correlation data of a deterioration factor and a temperature, and a control temperature determination unit 307 which determines a target temperature (may be referred to as control temperature) on the basis of the target life and a correlation between the deterioration factor and the temperature.

The capacity acquisition unit 303 which forms a part of the life prediction unit 301 will be described below. Since the BMU 202 has a function of performing full-charge management and remaining capacity management for the storage battery module 201, the capacity of the storage battery module 201 can be acquired by the BMU 202. It is also possible that the BMU 202 calculates the capacity of the storage battery module 201 by integrating a current value, for example. The BMU 202 can calculate a capacity Q by a method of integrating a current value I in charging from SOC 0% to SOC 100%, using the following Formula (1).

$$\begin{matrix}[ Mathematical 1 ] & \\ Q = {\int }_{SOC 0 \%}^{SOC 100 \%} Idt & ( 1 )\end{matrix}$$

In Formula (1), SOC (state of charge) is a parameter representing the charge state of the storage battery, SOC 0% represents a discharged state, and SOC 100% represents a charged state.

Other than the calculation method for the capacity Q by the above Formula (1), the BMU 202 can calculate the capacity Q at SOC 100% on the basis of the integral value of the current value I through change from SOC a % to SOC b % in a given interval, using the following Formula (2).

$$\begin{matrix}[ Mathematical 2 ] & \\ Q = {\int }_{SOCa}^{SOCb} Idt \times \frac{100}{b - a} ( b > a ) & ( 2 )\end{matrix}$$

The capacity acquisition unit 303 receives data regarding the capacities of the storage battery modules 201 outputted from the BMUs 202 respectively provided to the storage battery modules 201, calculates the capacities of all the storage battery modules 201, and outputs the capacities to the life calculation unit 304.

The life calculation unit 304 will be described below. Various methods are proposed as a life prediction method for the storage battery module based on the capacity at the time of prediction. Hereinafter, a general life prediction method will be described. The capacity Q of the storage battery module is represented by the following Formula (3) based on prediction using the square root of a usage period t_{w}.

$$\begin{matrix}[ Mathematical 3 ] & \\ Q = {Q}_{r} ( 1 - ( {k}_{w} \times \sqrt{{t}_{w}} ) ) & ( 3 )\end{matrix}$$

In Formula (3), Q is the present capacity of the storage battery module, Qᵣ is the rated capacity (initial capacity) of the storage battery module, k_{w} is the deterioration factor, and t_{w} is the usage period of the storage battery system.

A capacity when the storage battery system 100 reaches the end of life is denoted by Q_{L} and a period until the end of life is reached is denoted by t_{we}. The life end reaching period t_{we} is represented by a calculation formula of the following Formula (4). The capacity Q_{L} when the storage battery system 100 reaches the end of life is 0.6×Qᵣ in a case where the end of life is defined as deterioration to 60% of the initial capacity Qr, for example.

$$\begin{matrix}[ Mathematical 4 ] & \\ {t}_{we} = {( \frac{1 - \frac{{Q}_{L}}{{Q}_{r}}}{{k}_{W}} )}^{2} & ( 4 )\end{matrix}$$

The deterioration factor k_{w} in Formula (4) is determined by current applied to the storage battery module 201, the SOC range (setting of charge voltage and discharge voltage), a usage temperature, and the like. The deterioration factor k_{w} may be acquired in advance or may be acquired during operation, to predict the life.

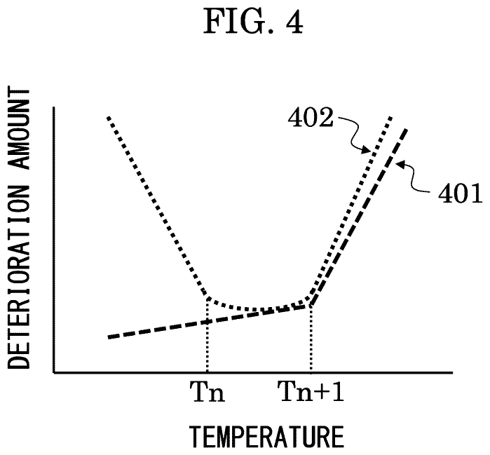

FIG. 4 schematically shows deterioration amounts in preservation deterioration and in combination of preservation deterioration and cycle deterioration of the storage battery module 201. In FIG. 4, in particular, characteristics of a temperature and a deterioration amount of a lithium-ion battery are shown. In a case of only preservation deterioration indicated by a dotted line 401, a side reaction product through decomposition of an electrolyte inside the storage battery is less produced at a lower temperature, and is more produced at a higher temperature. Therefore, the deterioration amount of the storage battery module 201 increases as the temperature becomes higher.

On the other hand, in a case of performing charge and discharge cycles as indicated by a dotted line 402, deterioration occurs due to deposition of lithium metal different from production of a side reaction product through decomposition of an electrolyte. Therefore, in a case where charge and discharge cycles are assumed, deterioration of the storage battery module 201 progresses also in a low-temperature region. In order to reduce the deterioration amount of the storage battery module 201, it is desirable that the storage battery module 201 is used under temperature management in a temperature range where decomposition of the electrolyte does not progress and where lithium metal is not deposited and the deterioration amount is small, e.g., a range from temperature Tn to temperature Tn+1 in FIG. 4.

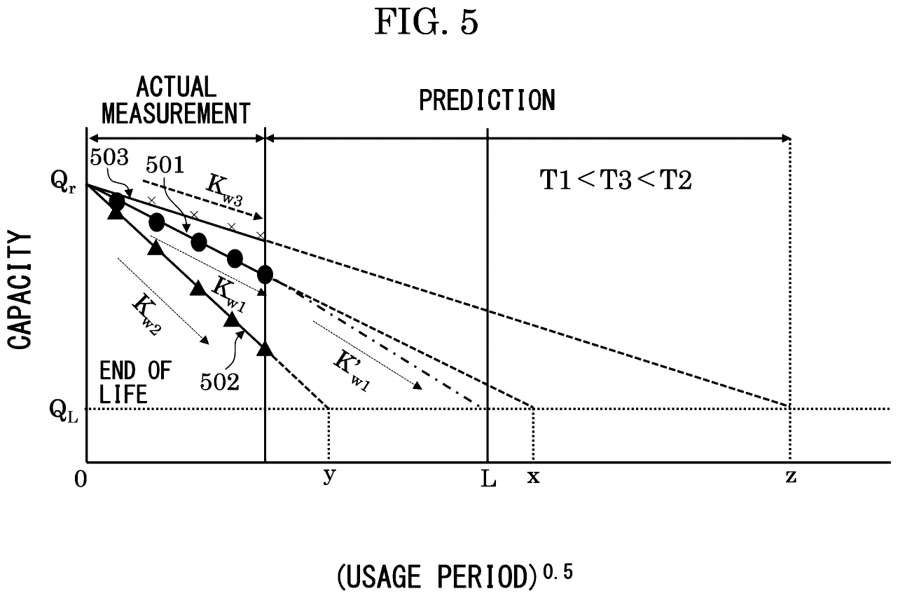

FIG. 5 shows transition of the capacities of storage battery modules 201a, 201b, 201c which are the storage battery modules 201 in the storage battery system 100 according to embodiment 1, where the horizontal axis indicates the square root of the usage period of each storage battery module 201. In FIG. 5, a capacity transition line 501 represents the storage battery module 201a, a capacity transition line 502 represents the storage battery module 201b, and the capacity transition line 503 represents the storage battery module 201c. In the case where capacity transition is plotted with the square root of the usage period of the storage battery module 201, the storage battery module 201 linearly deteriorates with the deterioration factor k_{w} as a slope, as shown by the above Formula (3). In the following description, the square root of the period may also be referred to as period, for convenience sake.

In FIG. 5, a deterioration factor K_{w1} represents a slope of capacity transition of the storage battery module 201a, a deterioration factor K_{w2} represents a slope of capacity transition of the storage battery module 201b, and a deterioration factor K_{w3} represents a slope of capacity transition of the storage battery module 201c. That is, depending on the temperatures and the usage conditions, the slopes are different among the plurality of storage battery modules 201.

The storage battery module 201a is used in a condition of temperature T1 and deterioration thereof progresses with the deterioration factor K_{w1} as a slope, so that the capacity decreases from the initial capacity Qᵣ at the start of usage over time. It is predicted that, when the square root of the usage period of the storage battery module 201a reaches x, the storage battery module 201a reaches the end of life defined by the capacity Q_{L} of the storage battery module.

The storage battery module 201b is used in a condition of temperature T2 and deterioration thereof progresses with the deterioration factor K_{w2} as a slope, so that the capacity decreases from the initial capacity Qᵣ at the start of usage over time. It is predicted that, when the square root of the usage period of the storage battery module 201b reaches y, the storage battery module 201b reaches the end of life defined by the capacity Q_{L} of the storage battery module.

The storage battery module 201c is used in a condition of temperature T3 and deterioration thereof progresses with the deterioration factor K_{w3} as a slope, so that the capacity decreases from the initial capacity Qᵣ at the start of usage over time. It is predicted that, when the square root of the usage period of the storage battery module 201c reaches z, the storage battery module 201c reaches the end of life defined by the capacity Q_{L} of the storage battery module.

The temperatures T1, T2, T3 have a relationship of T1<T3<T2, and it is found from FIG. 5 that deterioration tends to be smallest in the storage battery module 201c used at the temperature T3 which is in a middle region.

The target life determination unit 305 will be described with reference to FIG. 5. Regarding a target life, for example, a life prediction result (indicated by time x in FIG. 5) for the storage battery module 201a having a life that is closest to the average (hereinafter, referred to as average life Lₐᵥₑ) among the storage battery modules 201a, 201b, 201c provided in the storage battery system 100, is set as a target life L. The average life Lₐᵥₑ may be equal to the target life L of the storage battery system 100, but it is desirable that the average life Lₐᵥₑ is not less than the target life L of the storage battery system 100. In a case where the average life Lₐᵥₑ is set as the target life L, it is desirable to control the deterioration factors so as to achieve the target life L through temperature control on the basis of times x, y, z corresponding to the predicted lives of the respective storage battery modules 201a, 201b, 201c.

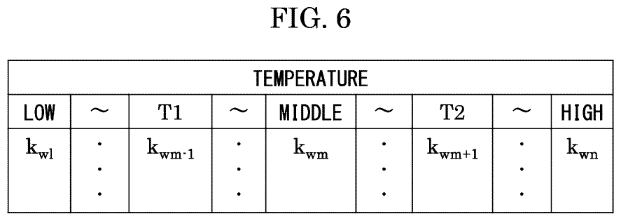

FIG. 6 shows correlation data of a deterioration factor k_{wn} and a temperature of the storage battery module 201 in the storage battery system 100 according to embodiment 1. The deterioration factor k_{wn} is determined by current applied to the storage battery module 201, the SOC range (setting of charge voltage and discharge voltage), and the usage temperature of the storage battery module 201. The deterioration factor k_{wn} may be acquired in advance or may be estimated on the basis of data of a capacity, a temperature, and the like acquired during operation. Alternatively, life tests may be conducted at various temperatures in advance, to acquire the deterioration factor k_{wn}, or the deterioration factor k_{wn} may be predicted in each temperature region by an Arrhenius equation. The storage battery system 100 according to embodiment 1 may use any of the above methods to acquire the deterioration factor k_{wn}.

As a method for acquiring the deterioration factor k_{w}, as shown in FIG. 6, deterioration factors k_{w} may be associated with respective temperatures, and the deterioration factor k_{wn} may be calculated with the target temperature set for the storage battery module 201. In the prediction method by the Arrhenius equation, if there are three or more data as temperature measurement points in actual measurement, accuracy of the deterioration factor k_{wn} is improved. The Arrhenius equation needed for calculating the deterioration factor k_{wn} is shown by the following Formula (5).

$$\begin{matrix}[ Mathematical 5 ] & \\ {k}_{wn} = A exp ( \frac{- Ea}{RTn} ) & ( 5 )\end{matrix}$$

In Formula (5), A is a constant, Ea is activation energy, R is a gas constant, and Tn is an absolute temperature. It is also possible that, on the basis of measurement data of the deterioration factor k_{wn} measured at a given temperature, the deterioration factor k_{wn} at another temperature is predicted. In the following description, correlation data of the deterioration factor k_{wn} and the temperature is used.

Next, the control temperature determination unit 307 forming a part of the temperature control unit 302 will be described. On the basis of correlation data of the deterioration factor k_{wn} and the temperature of the storage battery module 201, the control temperature determination unit 307 determines the target temperature for each storage battery module 201 individually in order to perform temperature control for each storage battery module 201 so as to make such a deterioration factor k_{wn} that can achieve the target life L.

The temperatures of the storage battery modules 201a, 201b, 201c including the storage battery module 201c having the longest life (hereinafter, referred to as maximum life Lₘₐₓ) and the storage battery module 201b having the shortest life (hereinafter, referred to as minimum life Lₘᵢₙ) are each controlled by the air conditioners 101, thereby causing the lives of the storage battery modules 201a, 201b, 201c to coincide with the life of the storage battery module having the average life Lₐᵥₑ. If the order of the lives of the storage battery modules 201a, 201b, 201c in the storage battery system 100 has changed as a result of the above temperature control, the storage battery modules that are control subjects are changed as appropriate.

In a case where the number of the plurality of storage battery modules 201 is larger than three, with respect to the storage battery modules having lives longer than the average life Lₐᵥₑ among the lives respectively predicted for the plurality of storage battery modules at a control start point, the control temperature determination unit 307 may calculate a target temperature for each of the plurality of storage battery modules so that the lives of the storage battery modules having the lives longer than the average life Lₐᵥₑ coincide with the target life such as the average life Lₐᵥₑ after the control start point. Meanwhile, with respect to the storage battery modules having lives shorter than the average life Lₐᵥₑ among the lives respectively predicted for the plurality of storage battery modules at the control start point, the control temperature determination unit 307 may calculate a target temperature for each of the plurality of storage battery modules so that the lives of the storage battery modules having the lives shorter than the average life Lₐᵥₑ coincide with the target life such as the average life Lₐᵥₑ after the control start point.

### <Storage Battery System Control Method According to Embodiment 1>

The storage battery system control method according to embodiment 1, i.e., a control temperature determination method and a method for causing the lives of the storage battery modules to coincide with each other, will be described below.

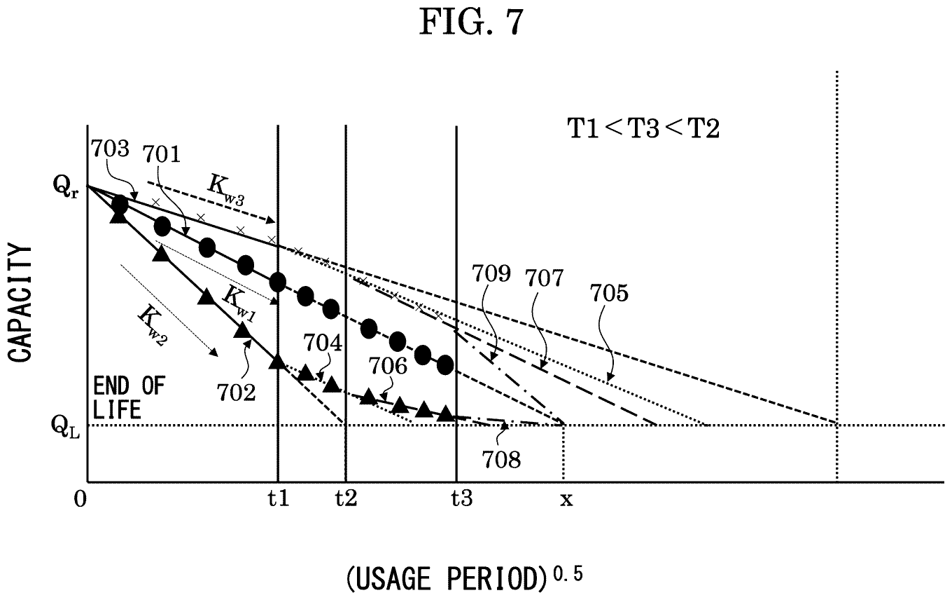

FIG. 7 shows capacity transition of each storage battery module 201a, 201b, 201c with respect to the usage period in a case where a temperature distribution has occurred in the storage battery system 100 according to embodiment 1. In FIG. 7, capacity transition is shown with respect to the square root of the usage period of each storage battery module 201a, 201b, 201c in a case where the storage battery module 201a is operated at the temperature T1, the storage battery module 201b is operated at the temperature T2, and the storage battery module 201c is operated at the temperature T3 during a period from when the usage period is zero to a control start point t1.

During the period from when the usage period is zero to the control start point t1 in FIG. 7, a capacity transition line 701 represents the storage battery module 201a, a capacity transition line 702 represents the storage battery module 201b, and a capacity transition line 703 represents the storage battery module 201c.

During the period from when the usage period is zero to the control start point t1, operation is performed without temperature control and therefore a temperature distribution occurs in the storage battery system 100. It is assumed that the temperatures of the storage battery modules 201a, 201b, 201c in operation are T1 (201a), T2 (201b), and T3 (201c), respectively. Due to the temperature distribution, the deterioration factors of the storage battery modules 201a, 201b, 201c have different values K_{w1}, K_{w2}, and K_{w3}. This indicates that deterioration speeds are different among the storage battery modules 201a, 201b, 201c. The magnitude relationship of the temperatures is assumed to be T1<T3<T2.

From the control start point t1, the storage battery system control method according to embodiment 1 is performed. During the period from when the usage period is zero to the control start point t1, as indicated by the capacity transition line 702, the storage battery module 201b has a high usage temperature of T2 and therefore the deterioration speed is great, i.e., the deterioration factor K_{w2} is great. Accordingly, after the control start point t1, in order to suppress deterioration in the storage battery module 201b, i.e., reduce the deterioration factor, the temperature of the storage battery module 201b is reduced through temperature control using the air conditioner 101.

As a result of temperature control for the storage battery module 201b, the deterioration speed decreases from the capacity transition line 702 to a capacity transition line 704 during a period from the control start point t1 to a control start point t2. Through further temperature control for the storage battery module 201b, the deterioration speed further decreases to a capacity transition line 706 during a period from the control start point t2 to a control start point t3 and then to a capacity transition line 708 after the control start point t3, so that the storage battery module 201b reaches the time x when the capacity becomes Q_{L} corresponding to the definition of life.

As a result of temperature control for the storage battery module 201c, the deterioration speed increases from the capacity transition line 703 to a capacity transition line 705 during a period from the control start point t1 to the control start point t2. Through further temperature control for the storage battery module 201c, the deterioration speed further increases to a capacity transition line 707 during the period from the control start point t2 to the control start point t3 and then to a capacity transition line 709 after the control start point t3, so that the storage battery module 201c reaches the time x when the capacity becomes Q₁, corresponding to the definition of life.

The storage battery module 201a has a usage temperature of T1 from when the usage period is zero to the control start point t1, and has the deterioration factor K_{w1} as indicated by the capacity transition line 701. According to prediction of the life of the storage battery module 201a based on the deterioration factor K_{w1}, the storage battery module 201c will reach the time x when the capacity becomes Q_{L} corresponding to the life, and therefore temperature control is not particularly performed for the storage battery module 201a or temperature control for keeping the usage temperature at T1 is performed using the air conditioner 101.

At arbitrary control points such as the control start points t1, t2, t3 shown in FIG. 7, the life of each storage battery module is predicted, and the direction of temperature control, i.e., whether to increase or decrease the temperature of the storage battery module, is determined for each storage battery module, whereby difference among the lives of the storage battery modules can be reduced.

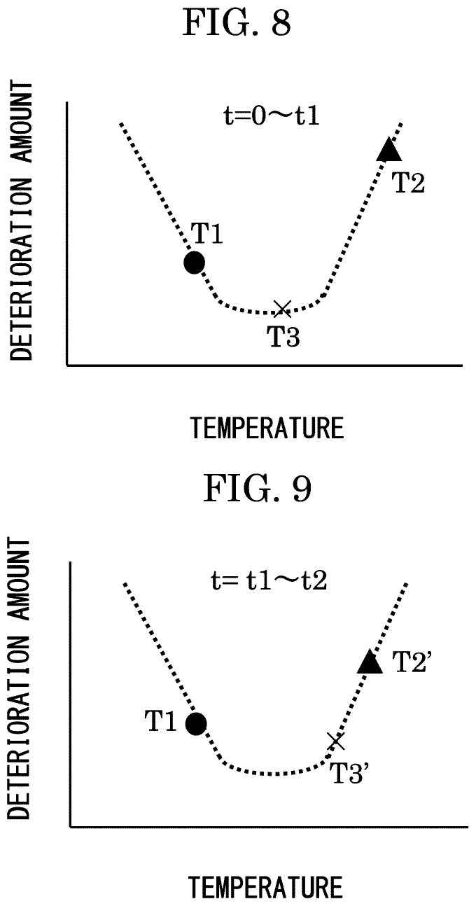

FIG. 8 to FIG. 11 show the relationship between a temperature distribution and deterioration amounts of the storage battery modules in the periods to the control start points t1, t2, t3, in the storage battery system 100 according to embodiment 1.

FIG. 8 shows the relationship between a temperature distribution and deterioration amounts of the storage battery modules 201a, 201b, 201c during the period from the start of the usage period to the control start point t1. According to a deterioration curve shown in FIG. 8, it is inferred that, during a period from the start of the usage period to the control start point t1, the temperature T2 of the storage battery module 201b is highest and the temperature T3 of the storage battery module 201c is in a middle temperature region, e.g., 20 to 30° C. In addition, it is inferred that the temperature T1 of the storage battery module 201a is lowest. That is, the temperatures have a relationship of T1<T3<T2.

The magnitude relationship of deterioration amounts of the storage battery modules 201a, 201b, 201c during the period to the control start point t1 is the storage battery module 201b>the storage battery module 201a>the storage battery module 201c, as shown in FIG. 8. In order to cause the lives of the storage battery modules to coincide with each other, temperature control is performed so as to increase or decrease the temperature of the storage battery module 201c and decrease the temperature of the storage battery module 201b.

FIG. 9 shows the relationship between a temperature distribution and deterioration amounts of the storage battery modules during the period from the control start point t1 to the control start point t2, in the storage battery system 100 according to embodiment 1. According to a deterioration curve shown in FIG. 9, it is inferred that, during the period from the control start point t1 to the control start point t2, a temperature T2′ of the storage battery module 201b is highest, a temperature T3′ of the storage battery module 201c is slightly higher than the middle temperature region, and the temperature T1 of the storage battery module 201a is lowest. Here, the difference between the temperature T2′ and the temperature T3′ is smaller than the difference between the temperature T1 and the temperature T3′.

The reason why the temperature of the storage battery module 201b decreases from the temperature T2 during the period from the start of the usage period to the control start point t1, to the temperature T2′ after the control start point t1, is as follows. At the control start point t1, the wind direction, the air volume, the wind-blow temperature, and the like of wind blown to the storage battery module 201b by the air conditioner 101 are controlled on the basis of a command from the temperature control unit 302, so that the storage battery module 201b is cooled and thus the temperature thereof decreases from the temperature T2 before the start of control to the temperature T2′ after the start of control.

The reason why the storage battery module 201c increases from the temperature T3 during the period from the start of the usage period to the control start point t1, to the temperature T3′ after the control start point t1, is as follows. At the control start point t1, the wind direction, the air volume, the wind-blow temperature, and the like of wind blown to the storage battery module 201c by the air conditioner 101 are controlled on the basis of a command from the temperature control unit 302, so that the temperature of the storage battery module 201c increases.

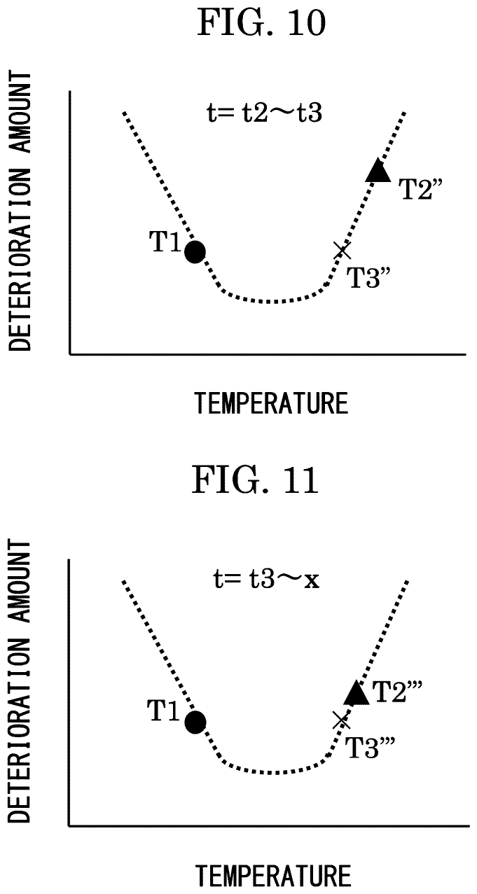

FIG. 10 shows the relationship between a temperature distribution and deterioration amounts of the storage battery modules during the period from the control start point t2 to the control start point t3, in the storage battery system 100 according to embodiment 1. According to a deterioration curve shown in FIG. 10, it is inferred that, during the period from the control start point t2 to the control start point t3, a temperature T2″ of the storage battery module 201b is highest and a temperature T3″ of the storage battery module 201c is slightly higher than the middle temperature region. In addition, it is inferred that the temperature T1 of the storage battery module 201a is lowest.

The reason why the temperature of the storage battery module 201b further decreases from the temperature T2′ during the period from the control start point t1 to the control start point t2, to the temperature T2″ after the control start point t2, is as follows. At the control start point t2, the wind direction, the air volume, the wind-blow temperature, and the like of wind blown to the storage battery module 201b by the air conditioner 101 are adjusted on the basis of a command from the temperature control unit 302, so that the storage battery module 201b is further cooled.

The reason why the temperature of the storage battery module 201c further changes from the temperature T3′ during the period from the control start point t1 to the control start point t2, to the temperature T3″ after the control start point t2, is as follows. At the control start point t2, the wind direction, the air volume, the wind-blow temperature, and the like of wind blown to the storage battery module 201c by the air conditioner 101 are adjusted on the basis of a command from the temperature control unit 302, so that the temperature of the storage battery module 201c further increases.

FIG. 11 shows the relationship between a temperature distribution and deterioration amounts of the storage battery modules during the period from the control start point t3 to the time x when the end of life is reached, in the storage battery system 100 according to embodiment 1. According to a deterioration curve shown in FIG. 11, it is inferred that, during the period from the control start point t3 to the time x when the end of life is reached, a temperature T2′″ of the storage battery module 201b is highest and a temperature T3′″ of the storage battery module 201c is slightly higher than the middle temperature region.

The reason why the temperature of the storage battery module 201b further decreases from the temperature T2″ during the period from the control start point t2 to the control start point t3, to the temperature T2′″ after the control start point t3, is as follows. At the control start point t3, the wind direction, the air volume, the wind-blow temperature, and the like of wind blown to the storage battery module 201b by the air conditioner 101 are adjusted on the basis of a command from the temperature control unit 302, so that the storage battery module 201b is further cooled. As a result of temperature control for the storage battery module 201b, the difference between the temperature T2′″ of the storage battery module 201b and the temperature T3′″ of the storage battery module 201c is further reduced.

The reason why the temperature of the storage battery module 201c changes from the temperature T3″ during the period from the control start point t2 to the control start point t3, to the temperature T3′″ after the control start point t3, is as follows. At the control start point t3, the wind direction, the air volume, the wind-blow temperature, and the like of wind blown to the storage battery module 201c by the air conditioner 101 are adjusted on the basis of a command from the temperature control unit 302, so that the difference between the temperature T3′″ of the storage battery module 201c and the temperature T2′″ of the storage battery module 201b is further reduced.

As described above, in the storage battery system control method according to embodiment 1, at each of the control start points t1, t2, t3, the lives of the respective storage battery modules 201a, 201b, 201c are predicted and target temperatures for the respective storage battery modules 201a, 201b, 201c are individually determined.

In the above description, in the storage battery system control method according to embodiment 1, the temperatures of both of the storage battery modules 201b and 201c are controlled. However, since the temperature of the storage battery module 201c can be controlled in both directions of increase and decrease, temperature control based on control of the storage battery module 201b may be performed such that the temperature of the storage battery module 201c is not controlled while the temperature of the storage battery module 201b is controlled. In a case of performing only temperature control of the storage battery module 201b, the load on the air conditioners 101 is reduced and therefore further improvement in efficiency of the air conditioners 101 is expected.

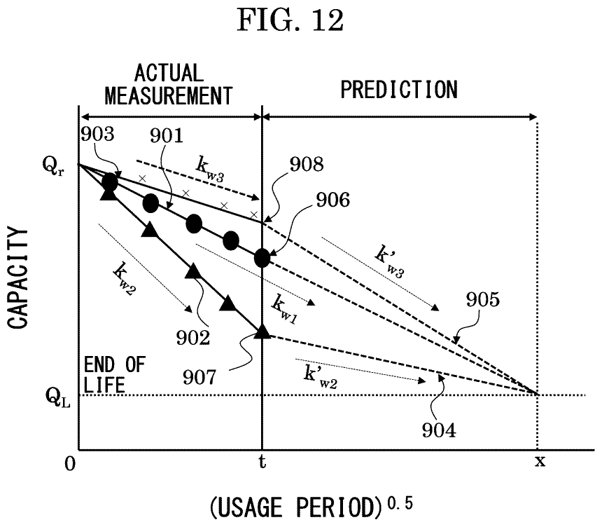

FIG. 12 shows an example of a method for individually controlling the temperature of each storage battery module using the capacity of the storage battery module at a control start point, in the storage battery system 100 and the storage battery system control method according to embodiment 1.

In a case where the capacities of the storage battery modules 201a, 201b, 201c are respectively determined to be capacities Q_{La}, Q_{Lb}, Q_{Lc} at a control start point t, a deterioration factor k_{wm} is calculated by the following Formula (6).

$$\begin{matrix}[ Mathematical 6 ] & \\ {k}_{wm} = \frac{{Q}_{Ln} - {Q}_{e}}{{Q}_{Lb} - {Q}_{e}} {k}_{w 1} & ( 6 )\end{matrix}$$

In Formula (6), the deterioration factor k_{wm} is a deterioration factor of the storage battery module to be calculated, Q_{Ln} is a capacity of the storage battery module that is a control subject at the control start point, Q_{Lb} is a capacity of the storage battery module as a reference for the deterioration factor k_{w1} at the control start point, Qₑ is a capacity at the end of life, and the deterioration factor k_{w1} is a deterioration factor of the storage battery module as a reference. That is, using Formula (6), on the basis of a ratio of a difference value between the capacity Q_{Ln} of the storage battery module that is a control subject at the control start point and the capacity Qₑ corresponding to the target life and a difference value between the capacity Q_{Lb} of the storage battery module as a reference for the deterioration factor k_{w1} at the control start point and the capacity Q_{Ln} corresponding to the target life, the control temperature determination unit 307 calculates the deterioration factor k_{wm} of the storage battery module that is a control subject, and determines the target temperature therefor.

On the basis of correlation data of the deterioration factor k_{wn} and the temperature of the storage battery module 201 stored in the data storage unit 306 of the temperature control unit 302 shown in FIG. 6, the target life determination unit 305 of the temperature control unit 302 determines the target life by referring to the deterioration factors k_{w1}, k_{w2}, k_{w3} of the respective storage battery modules 201a, 201b, 201c.

The control temperature determination unit 307 of the temperature control unit 302 sets a target temperature for each storage battery module that is a control subject. The control temperature determination unit 307 outputs the set target temperature to the air conditioner 101, and the air conditioner 101 adopts the target temperature as a control target value.

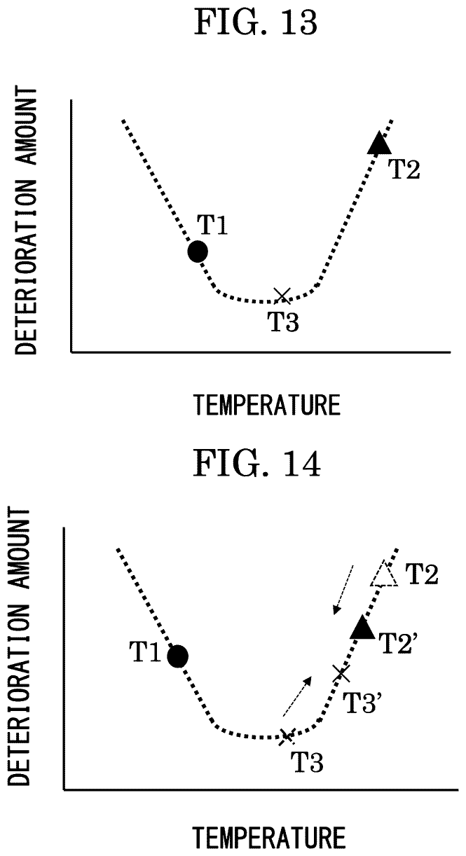

FIG. 13 and FIG. 14 schematically show temperature control of the storage battery modules 201a, 201b, 201c. It is assumed that the storage battery modules 201a, 201b, 201c are respectively operating at the temperatures T1, T2, T3 before the start of control by the storage battery system control method according to embodiment 1. The control device 104 of the storage battery system 100 predicts deterioration of each of the storage battery modules 201a, 201b, 201c and determines a target temperature for each storage battery module.

In the example shown in FIG. 13, since the temperatures have a relationship of T2>T3>T1 before the start of control, the control device 104 determines that temperature control for the storage battery module 201b and the storage battery module 201c needs to be performed. On the basis of a prediction result for the lives of the storage battery modules 201a, 201b, 201c by the life calculation unit 304, the control device 104 determines that the temperature of the storage battery module 201b needs to be controlled to be the temperature T2′ on a low-temperature side from the temperature T2 before the control start point t, as shown in FIG. 14.

Meanwhile, the control device 104 determines that the temperature of the storage battery module 201c needs to be controlled to a high-temperature side or a low-temperature side from the temperature T3 before the control start point. In the example shown in FIG. 14, the control device 104 determines that the temperature of the storage battery module 201c needs to be controlled toward a high-temperature side from the temperature T3.

To summarize the above, at the control start point t, the wind direction, the air volume, and the wind-blow temperature of the air conditioner 101 are controlled on the basis of a command from the temperature control unit 302, whereby the temperature of the storage battery module 201b is controlled toward a low-temperature side and the temperature of the storage battery module 201c is controlled toward a high-temperature side. As a result of the temperature control, the difference between the temperature T1 of the storage battery module 201a and the temperature T2′ of the storage battery module 201b after the start of control decreases and the difference between the temperature T1 of the storage battery module 201a and the temperature T3′ of the storage battery module 201c after the start of control increases.

In the above description, the case where the air conditioners 101 perform temperature control for the storage battery modules 201 individually has been shown as an example. However, temperature control may be performed for each of divided storage battery areas. In a case of performing temperature control for each storage battery area, temperature control may be performed using, as a reference, an average temperature which is an average value of the temperatures of the storage battery modules provided in each storage battery area or the temperature of the storage battery module that is a representative for the storage battery area.

As shown in FIG. 12, before the control start point t, the capacity of the storage battery module 201a changes along a capacity transition line 901 with the deterioration factor k_{w1} as a slope, the capacity of the storage battery module 201b changes along a capacity transition line 902 with the deterioration factor k_{w2} as a slope, and the capacity of the storage battery module 201c changes along a capacity transition line 903 with the deterioration factor k_{w3} as a slope. After the control start point t, the above temperature control is performed, so that the capacity of the storage battery module 201a changes still along the capacity transition line 901 while keeping the deterioration factor k_{w1}, the capacity of the storage battery module 201b changes along a capacity transition line 904 with a deterioration factor k′_{w2} as a slope, and the capacity of the storage battery module 201c changes along a capacity transition line 905 with a deterioration factor k′_{w3} as a slope. In FIG. 12, a control start point capacity 906 represents the capacity of the storage battery module 201a at the control start point t, a control start point capacity 907 represents the capacity of the storage battery module 201b at the control start point t, and a control start point capacity 908 represents the capacity of the storage battery module 201c at the control start point t.

After the control start point t, the deterioration speeds of the storage battery module 201b and the storage battery module 201c are adjusted through the temperature control, so that all the storage battery modules 201a, 201b, 201c reach the time x when the capacity becomes Q_{L} corresponding to the life. That is, the lives of the storage battery modules 201a, 201b, 201c coincide with the time x.

In the above description, for the storage battery module 201c, temperature control is performed so as to increase the temperature thereof. However, a temperature control value (target temperature) may be set toward a low-temperature side so as to promote deterioration.

In the above description, the example in which the temperature T2 of the storage battery module 201b and the temperature T3 of the storage battery module 201c are both controlled, has been shown. However, since the temperature T3 of the storage battery module 201c can be controlled in both directions of increase and decrease, temperature control based on control of the storage battery module 201b may be performed such that only the temperature of the storage battery module 201b is controlled and the temperature of the storage battery module 201c is not controlled. In a case of performing only temperature control for the temperature T2 of the storage battery module 201b, the load on the air conditioners 101 is reduced and therefore further improvement in efficiency of the air conditioners is expected.

When the target temperatures for the respective storage battery modules 201 have been determined, the control device 104 transmits commands to the air conditioners 101, to perform control for the wind direction, the air volume, and the wind-blow temperature of the blown wind for each storage battery module 201. Each air conditioner 101 operates with a wind direction θ0, an air volume W0, and the wind-blow temperature TO before control, and then operates with a wind direction θ0+Δθ, an air volume W0+ΔW, and a wind-blow temperature T0+ΔT after control, so that the target temperature for the storage battery module 201 shifts toward a control target value set individually.

In the above description, temperature control using the air conditioner 101 is performed by changing all the parameters of the wind direction, the air volume, and the wind-blow temperature of the blown wind. However, as long as the target temperature for the storage battery module 201 shifts toward a control target value set individually, at least one parameter of the wind direction, the air volume, and the wind-blow temperature of the blown wind may be controlled. For example, temperature control for each storage battery module 201 may be performed using only the air volume of wind blown from the air conditioner 101.

### <Storage Battery System Control Method According to Embodiment 1>

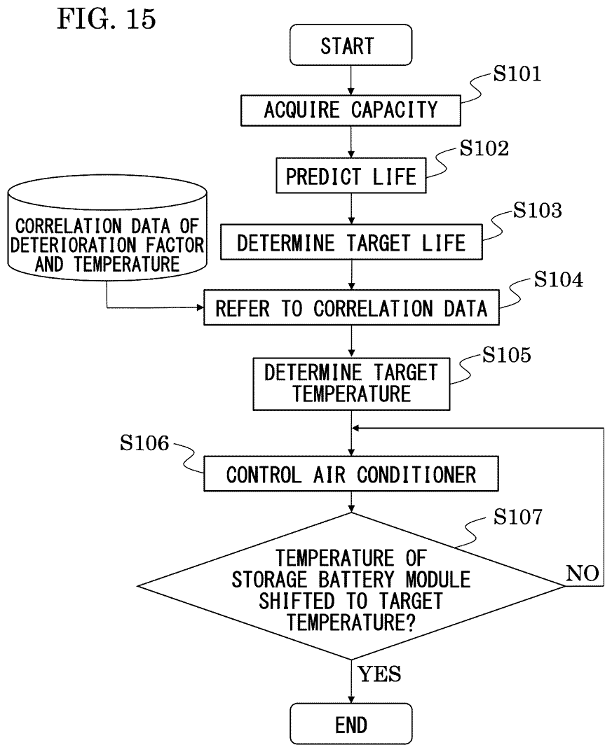

With reference to a flowchart shown in FIG. 15, a control flow in the storage battery system control method according to embodiment 1 will be described.

In step S101, control by the storage battery system control method according to embodiment 1 is started. The capacity acquisition unit 303 in the control device 104 acquires the capacity of each storage battery module 201 outputted from the BMUs 202 provided to the respective storage battery modules 201 in the storage battery system 100.

In step S102, the life calculation unit 304 in the control device 104 analyzes the acquired capacity of each storage battery module 201 in time series, and calculates the life of each storage battery module 201.

In step S103, the target life determination unit 305 in the control device 104 determines a target life for causing the lives of the storage battery modules 201 to coincide with the life of the storage battery module closest to the average life Lₐᵥₑ which is the average of the lives of the respective storage battery modules 201.

In step S104, correlation data of the deterioration factor k_{w} and a temperature stored in the data storage unit 306 in the control device 104 is referred to.

In step S105, the control temperature determination unit 307 in the control device 104 determines a target temperature for each storage battery module 201.

In step S106, the control temperature determination unit 307 in the control device 104 transmits commands for air conditioner control based on the target temperatures, to the air conditioners 101 via the signal lines 106. The commands for air conditioner control may be transmitted via wireless communication instead of the signal lines 106.

In step S107, for each storage battery module 201, the control device 104 individually determines whether or not the temperature of the storage battery module 201 has shifted to the target temperature. If the temperature of each storage battery module 201 has shifted to the target temperature, i.e., in a case of YES in step S107, the control is ended. On the other hand, if shift to the target temperature has not been completed, i.e., in a case of NO in step S107, the process returns to step S106, to continue the air conditioner control.

Operations in the storage battery system control method according to embodiment 1 are as described above.

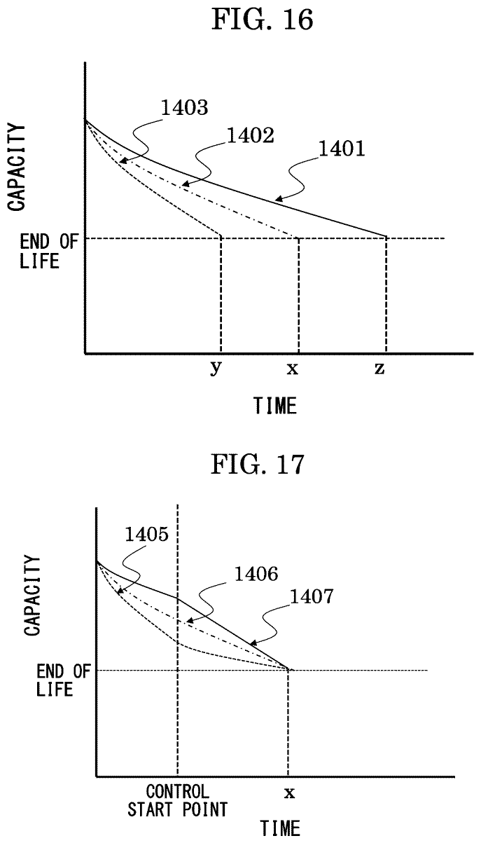

FIG. 16 and FIG. 17 respectively show capacity transitions of respective storage battery modules in a storage battery system in a comparative example, and capacity transitions of the respective storage battery modules in the storage battery system in a case where the storage battery system control method according to embodiment 1 is applied. As the comparative example, capacity transition in a case where the storage battery system control method according to embodiment 1 is not applied, is shown.

FIG. 16 shows capacity transitions of the respective storage battery modules in the comparative example. In the case where the storage battery system control method according to embodiment 1 is not applied, due to a temperature distribution in the storage battery system, the deterioration speeds are different among the storage battery modules and therefore the life of the entire storage battery system is limited to a short life among the storage battery modules, so that the life of the storage battery system is shortened. Hereinafter, this will be specifically described with reference to FIG. 16.

The capacity transitions of the storage battery modules 201a, 201b, 201c over time are respectively represented by capacity transition lines 1401, 1402, 1403 in FIG. 16. The storage battery module 201a deteriorates over time along the capacity transition line 1401, to reach the end of life at a time z. The storage battery module 201b deteriorates over time along the capacity transition line 1402, to reach the end of life at a time x. The storage battery module 201c deteriorates over time along the capacity transition line 1403, to reach the end of life at a time y.

That is, the deterioration factor k_{w} of the storage battery module 201c is greatest and the deterioration factor k_{w} of the storage battery module 201a is smallest. Therefore, the magnitude relationship of the times x, y, z at which each storage battery module reaches the end of life is z>x>y. Thus, the storage battery module 201c reaches the end of life earliest. The life of the entire storage battery system including a plurality of storage battery modules 201 is determined by the storage battery module that reaches the end of life earliest. That is, in the above example, the time y for the storage battery module 201c corresponds to the life of the entire storage battery system in the comparative example.

FIG. 17 shows capacity transitions of the respective storage battery modules 201 in the storage battery system 100 according to embodiment 1. In the case where the storage battery system control method according to embodiment 1 is applied, before the control start point, the deterioration speeds are different among the storage battery modules 201 due to a temperature distribution in the storage battery system, but after the control start point, the lives of the storage battery modules 201a, 201b, 201c coincide with the time x, so that the life of the entire storage battery system 100 increases. Hereinafter, this will be specifically described with reference to FIG. 17.

The capacity transitions of the storage battery modules 201a, 201b, 201c over time are respectively represented by capacity transition lines 1407, 1406, 1405 in FIG. 17. Along the capacity transition line 1407, the storage battery module 201a deteriorates over time but the degree of deterioration is relatively small before the control start point. Along the capacity transition line 1406, the storage battery module 201b deteriorates with a constant deterioration factor k_{w} as a slope over time after the control start point, and then reaches the end of life at the time x. Along the capacity transition line 1405, the storage battery module 201c deteriorates over time and the degree of deterioration is great before the control start point.

That is, before the control start point, the deterioration factor k_{w} of the storage battery module 201c is greatest and the deterioration factor k_{w} of the storage battery module 201a is smallest. Therefore, it is predicted that the storage battery module 201c will reach the end of life earliest. After the control start point, the control device 104 performs control so as to increase the deterioration factor k_{w} of the storage battery module 201a and decrease the deterioration factor k_{w} of the storage battery module 201c, through temperature control using the air conditioners 101. As a result, the lives of the storage battery modules 201a, 201b, 201c coincide with the time x.

That is, by applying the storage battery system control method according to embodiment 1, it becomes possible to equalize the deterioration speeds of the respective storage battery modules, and as a result, the lives of the storage battery modules can be made uniform. Making the lives of the storage battery modules uniform leads to increase in the life of the storage battery system. In the storage battery system control method according to embodiment 1, “making the lives uniform” means that the lives of the storage battery modules 201 composing the storage battery system 100 are controlled to be within a range of ±5% from the average life Lₐᵥₑ of the storage battery modules 201.

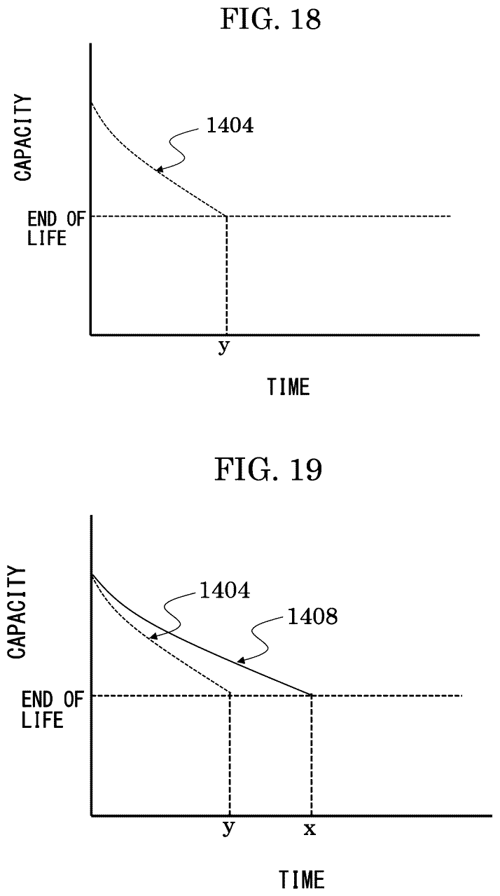

FIG. 18 and FIG. 19 respectively show capacity transition of the entire storage battery system in the comparative example, and capacity transition of the entire storage battery system in a case where the storage battery system control method according to embodiment 1 is applied. As the comparative example, capacity transition in a case where the storage battery system control method according to embodiment 1 is not applied, is shown.

As shown in FIG. 18, the life of the entire storage battery system in the comparative example is determined by the time y corresponding to the life of the storage battery module 201c composing the storage battery system shown in FIG. 16. That is, the life of the entire storage battery system in the comparative example is determined by the time y corresponding to the life of the storage battery module 201c which is shortest in the storage battery system in the comparative example.

On the other hand, the life of the storage battery system 100 according to embodiment 1 represented by a capacity transition line 1408 in FIG. 19 is determined by the time x corresponding to the lives of all the storage battery modules 201 determined after the start of control. That is, it is possible to reach the time x corresponding to a longer life than the time y corresponding to the life of the entire storage battery system in the comparative example represented by a capacity transition line 1404 in FIG. 19.

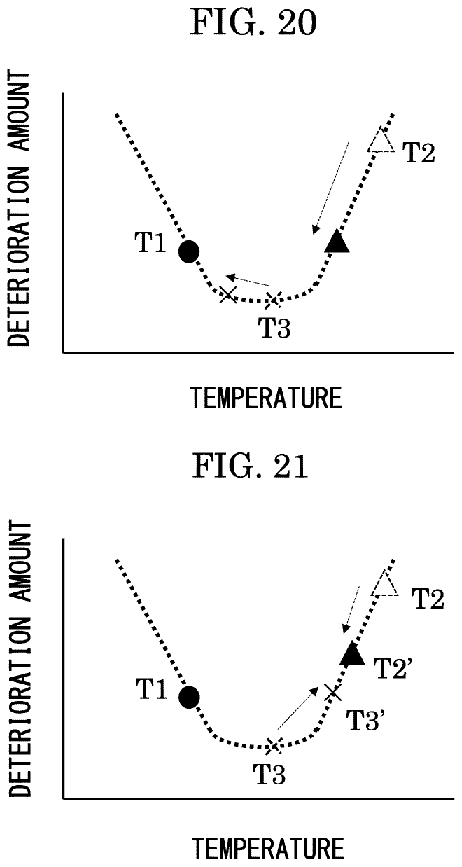

FIG. 20 and FIG. 21 respectively show temperature transition through temperature control in the comparative example, and temperature transition through temperature control in a case where the storage battery system control method according to embodiment 1 is applied. In control in the storage battery system in the comparative example shown in FIG. 20, the storage battery module having a high temperature is cooled using a target temperature (in FIG. 20, the temperature of the storage battery module on a low-temperature side) as a control target, in order to make temperatures in the storage battery system uniform.

On the other hand, in the storage battery system control method according to embodiment 1, as shown in FIG. 21, a control target is to cause the lives of the storage battery modules 201 to coincide with each other, and therefore it is not necessary to make the temperatures of the storage battery modules 201 uniform. Thus, in cooling of the storage battery modules 201, it is possible to set a higher temperature than in control in the comparative example, as a local target temperature.

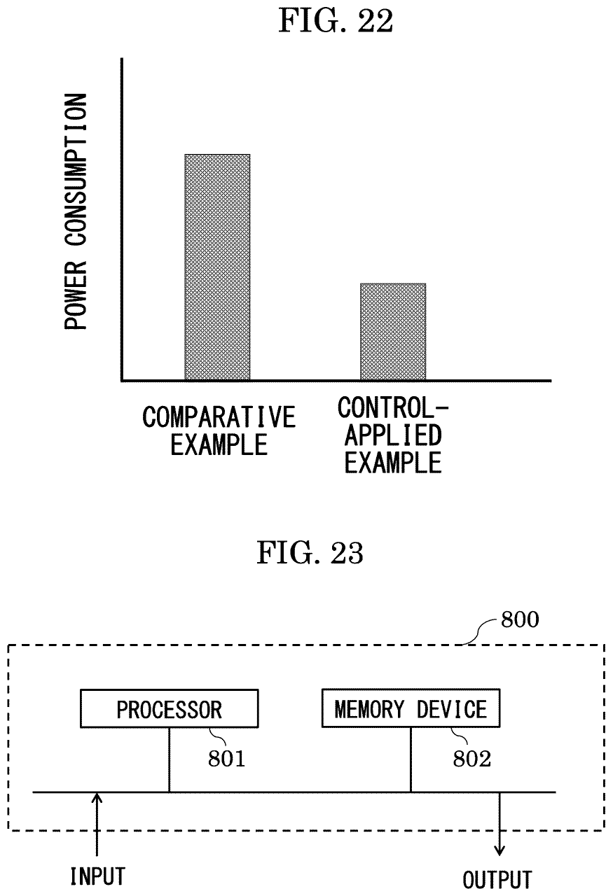

In the storage battery system control method according to embodiment 1, depending on a life prediction result, there can be a storage battery module 201 to be heated, and meanwhile, depending on control for the wind directions, the air volumes, and the wind-blow temperatures of winds blown from the air conditioners 101, some storage battery modules 201 are automatically heated, and temperature control need not be performed for such storage battery modules 201. As a result, as shown in FIG. 22, power consumption of the air conditioners 101 can be suppressed, thus providing an effect of contributing to increase in efficiency of the entire storage battery system 100.

### Effects of Embodiment 1

With the storage battery system and the storage battery system control method according to embodiment 1, the lives of a plurality of storage battery modules provided in the storage battery system can be made uniform, thus providing an effect that the entire storage battery system can be used until the end of the original target life. In addition, since it is not necessary to uniformly perform temperature control so that the storage battery modules have an average temperature, the storage battery modules can be prevented from being excessively cooled, thus providing an effect of increasing efficiency of the air conditioners.

In the above configuration of the storage battery system 100 according to embodiment 1, the storage battery system 100 is described as function blocks, whereas FIG. 23 shows an example of the configuration of hardware for storing the storage battery system 100. Hardware 800 is composed of a processor 801 and a memory device 802. Although not shown, the memory device 802 is provided with a volatile memory such as a random access memory and a nonvolatile auxiliary memory such as a flash memory.

Instead of the flash memory, an auxiliary memory of a hard disk may be provided. The processor 801 executes a program inputted from the memory device 802. In this case, the program is inputted from the auxiliary memory to the processor 801 via the volatile memory. The processor 801 may output data such as a calculation result to the volatile memory of the memory device 802, or may store such data into the auxiliary memory via the volatile memory.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

100 storage battery system
101 air conditioner
102 storage battery rack
103 converter
104 control device
105 temperature sensor
106 signal line
150 housing
201, 201a, 201b, 201c storage battery module
202 BMU
203 storage battery cell
301 life prediction unit
302 temperature control unit
303 capacity acquisition unit
304 life calculation unit
305 target life determination unit
306 data storage unit
307 control temperature determination unit
401, 402 dotted line
501, 502, 503, 701, 702, 703, 704, 705, 706, 707, 708, 709, 901, 902, 903, 904, 905, 1401, 1402, 1403, 1404, 1405, 1406, 1407, 1408 capacity transition line
800 hardware
801 processor
802 memory device
906, 907, 908 control start point capacity

1. A storage battery system comprising:
a plurality of storage battery modules each including a plurality of storage battery cells, a battery manager which controls the plurality of storage battery cells, and at least one temperature sensor;
control circuitry configured to control the plurality of storage battery modules via the battery managers; and
an air conditioner of which at least one of an air volume, a wind direction, and a wind-blow temperature of blown wind is controlled for each of the plurality of storage battery modules on the basis of a target temperature set for each storage battery module, wherein
the control circuitry includes
a life predictor which predicts a life of each of the plurality of storage battery modules, using a capacity of each of the plurality of storage battery modules and a temperature measured by the temperature sensor for each of the plurality of storage battery modules, and
a temperature controller which calculates the target temperature for each of the plurality of storage battery modules so that the life of each of the plurality of storage battery modules predicted by the life predictor at a control start point becomes an averaged life after the control start point, and transmits the target temperature to the air conditioner.
the temperature controller includes a control temperature determinator, and
with respect to the storage battery module having a shorter life than an average value of the lives predicted for the plurality of storage battery modules at the control start point, the control temperature determinator calculates the target temperature for each of the plurality of storage battery modules so that the life of the storage battery module shorter than the average value coincides with the average value of the lives after the control start point, or with respect to the storage battery module having a longer life than an average value of the lives predicted for the plurality of storage battery modules at the control start point the control temperature determinator calculates the target temperature for each of the plurality of storage battery modules so that the life of the storage battery module longer than the average value coincides with the average value of the lives after the control start point.

2. The storage battery system according to claim 1, wherein
the battery manager measures the capacity of the storage battery module, and
the life predictor predicts the life of each of the plurality of storage battery modules on the basis of a deterioration factor represented as a slope of transition of the capacity with respect to a square root of a usage period, using transition data of the capacity of the storage battery module.

3.-4. (canceled)

5. The storage battery system according to claim 2, wherein
on the basis of a ratio of a difference value between the capacity of the storage battery module that is a control subject at the control start point and a capacity corresponding to a target life and a difference value between the capacity of the storage battery module as a reference for the deterioration factor at the control start point and the capacity corresponding to the target life, the control temperature determinator calculates a deterioration speed of the storage battery module that is the control subject, and determines the target temperature therefor.

6. The storage battery system according to claim 1, wherein
the temperature sensor is provided for each of the plurality of storage battery cells composing the storage battery module, and an average value of temperatures of the plurality of storage battery cells measured for the respective storage battery cells is used as the temperature of the storage battery module.

7. The storage battery system according to claim 1, wherein
one said temperature sensor is provided in the storage battery module, and a temperature measured by the one temperature sensor is used as the temperature of the storage battery module.

8. The storage battery system according to claim 1, further comprising a converter connected to the battery manager.

9. The storage battery system according to claim 1, wherein
the battery manager measures a current value of the storage battery cell.

10. A method for controlling a storage battery system including a plurality of storage battery modules each including a plurality of storage battery cells, a battery manager which controls the plurality of storage battery cells, and at least one temperature sensor, the method comprising:
acquiring a capacity of each of the plurality of storage battery modules via the battery managers;
measuring a temperature of the storage battery module by at least one temperature sensor provided in each of the plurality of storage battery modules;
predicting a life of each storage battery module, using the capacity and the temperature of each of the plurality of storage battery modules;
calculating a target temperature for each of the plurality of storage battery modules so that the life predicted for each of the plurality of storage battery modules becomes an averaged life; and
controlling at least one of an air volume, a wind direction, and a wind-blow temperature of wind blown for each of the storage battery modules from an air conditioner, on the basis of the target temperature, wherein
with respect to the storage battery module having a shorter life than an average value of the lives predicted for the plurality of storage battery modules at a control start point, the target temperature is calculated for each of the plurality of storage battery modules so that the life of the storage battery module shorter than the average value coincides with the average value of the lives after the control start point or with respect to the storage battery module having a longer life than an average value of the lives predicted for the plurality of storage battery modules at the control start point, the target temperature is calculated for each of the plurality of storage battery modules so that the life of the storage battery module longer than the average value coincides with the average value of the lives after the control start point.

11.-12. (canceled)

13. A method for controlling a storage battery system including a plurality of storage battery modules each including a plurality of storage battery cells, a battery manager which controls the plurality of storage battery cells, and at least one temperature sensor, the method comprising:
acquiring a capacity of each of the plurality of storage battery modules via the battery managers;
measuring a temperature of the storage battery module by at least one temperature sensor provided in each of the plurality of storage battery modules;
predicting a life of each storage battery module, using the capacity and the temperature of each of the plurality of storage battery modules;
for each of the plurality of storage battery modules, determining a target temperature by calculating a deterioration speed of the storage battery module that is a control subject on the basis of a ratio of a difference value between the capacity of the storage battery module that is the control subject at a control start point and a capacity corresponding to a target life and a difference value between the capacity of the storage battery module as a reference for a deterioration factor at the control start point and the capacity corresponding to the target life, so that the life predicted for each of the plurality of storage battery modules on the basis of the deterioration factor represented as a slope of transition of the capacity with respect to a square root of a usage period, using transition data of the capacity of the storage battery module measured by the battery manager, becomes an averaged life; and
controlling at least one of an air volume, a wind direction, and a wind-blow temperature of wind blown for each of the storage battery modules from an air conditioner, on the basis of the target temperature.
